(19) United States
(12) Patent Application Publication
(10) Pub. No.: US 2024/0340722 A1
(43) Pub. Date: Oct. 10, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Xin YOU, Dongguan (CN); Jiangsheng FAN, Dongguan (CN)

(73) Assignee: GUANGDONG OPPO MOBILE TELECOMMUNICATIONS CORP., LTD., Dongguan (CN)

(21) Appl. No.: 18/745,342

(22) Filed: Jun. 17, 2024

Related U.S. Application Data
(63) Continuation of application No. PCT/CN2021/138895, filed on Dec. 16, 2021.

(51) Int. Cl. H04W 36/00

(52) U.S. Cl. CPC H04W 36/0072; H04W 36/0058; H04W 36/00835

(57) ABSTRACT

Embodiments of this application provide a wireless communication method, a terminal device, and a network device. The method includes: reporting, by a MAC layer of the terminal device, first indication information to a radio resource control RRC layer of the terminal device, so as to trigger the RRC layer to send an RRC reconfiguration complete message to a network device, where the first indication information is used to indicate that the terminal device has completed a handover of a serving cell; or sending, by a layer 1 or a layer 2 of the terminal device, the first indication information to the network device.

### CROSS-REFERENCE TO RELATED APPLICATIONS

This application is a continuation of International Application No. PCT/CN2021/138895, filed on Dec. 16, 2021, the disclosure of which is hereby incorporated by reference in its entirety.

### TECHNICAL FIELD

Embodiments of this application relate to the communication field, and more specifically, to a wireless communication method, a terminal device, and a network device.

### RELATED ART

A new radio (NR) system supports a handover process of a UE in a connected state. Similar to a long term evolution (LTE) system, when a user who is using a network service moves from one cell to another cell, or due to reasons such as adjustment of a load of a wireless transmission service, activation operation and maintenance, and a device fault, to ensure continuity of communication and quality of service, the system needs to transfer a communication link between the user and an original cell to a new cell, which may be implemented by executing a cell handover procedure.

However, to date, a cell handover procedure is implemented based on measurement reporting of a terminal and network configuration. However, measurement and reporting of a terminal and network configuration are necessarily related to interaction of a plurality of pieces of signaling, so that a relatively large delay exists in a cell handover. Therefore, a wireless communication method is urgently needed in the art to reduce a handover delay.

### SUMMARY

Embodiments of this application provide a wireless communication method, a terminal device, and a network device.

According to a first aspect, this application provides a wireless communication method, including:
reporting, by a medium access control MAC layer of the terminal device, first indication information to a radio resource control RRC layer of the terminal device, so as to trigger the RRC layer to send an RRC reconfiguration complete message to a network device, where the first indication information is used to indicate that the terminal device has completed a handover of a serving cell; or
sending, by a layer 1 or a layer 2 of the terminal device, the first indication information to the network device.

According to a second aspect, this application provides a wireless communication method, including:
receiving, by a layer 1 or a layer 2 of the network device, first indication information sent by a terminal device, where the first indication information is used to indicate that the terminal device has completed a handover of a serving cell.

According to a third aspect, this application provides a terminal device, including a processor and a memory, wherein the memory is configured to store a computer program, and the processor is configured to invoke and run the computer program stored in the memory to cause the terminal device to perform:
reporting, by a medium access control MAC layer of the terminal device, first indication information to a radio resource control RRC layer of the terminal device, so as to trigger the RRC layer to send an RRC reconfiguration complete message to a network device, wherein the first indication information is used to indicate that the terminal device has completed a handover of a serving cell; or
sending, by a layer 1 or a layer 2 of the terminal device, the first indication information to the network device.

### BRIEF DESCRIPTION OF DRAWINGS

FIG. 1 is an example of a system framework according to an embodiment of this application.

FIG. 2 is a schematic flowchart of a cell handover method according to an embodiment of this application.

FIG. 3 is a schematic flowchart of a conditional handover according to an embodiment of this application.

FIG. 4 and FIG. 5 are schematic flowcharts of a wireless communication method according to an embodiment of this application.

FIG. 6 is a schematic block diagram of a terminal device according to an embodiment of this application.

FIG. 7 is a schematic block diagram of a network device according to an embodiment of this application.

FIG. 8 is a schematic block diagram of a communications device according to an embodiment of this application.

FIG. 9 is a schematic block diagram of a chip according to an embodiment of this application.

### DESCRIPTION OF EMBODIMENTS

The following describes the technical solutions in embodiments of this application with reference to the accompanying drawings.

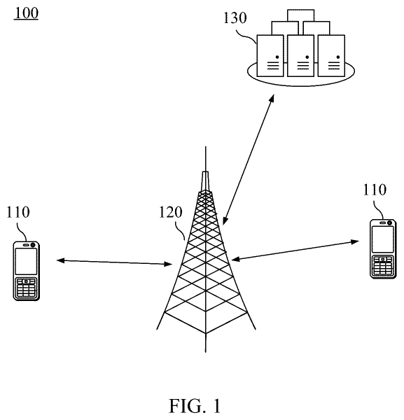

FIG. 1 is an example of a system framework 100 according to an embodiment of this application.

As shown in FIG. 1, the communications system 100 may include terminal devices 110 and a network device 120. The network device 120 may communicate with the terminal devices 110 by using air interfaces. Multi-service transmission is supported between the terminal devices 110 and the network device 120.

It should be understood that the communications system 100 is merely used as an example for description in this embodiment of this application, but this embodiment of this application is not limited thereto. That is, the technical solutions in embodiments of this application may be applied to various communications systems, for example, a long term evolution (LTE) system, an LTE time division duplex (TDD) system, a universal mobile telecommunication system (UMTS) system, an internet of things (IoT) system, a narrow band internet of things (NB-IoT) system, an enhanced machine-type communications (eMTC) system, a 5G communications system (also referred to as a new radio (NR) communications system), or a future communications system.

In the communications system 100 shown in FIG. 1, the network device 120 may be an access network device that communicates with the terminal devices 110. The access network device may provide communication coverage for a specific geographical area, and may communicate with a terminal device 110 (such as a UE) located in the coverage area.

The network device 120 may be an evolved NodeB (eNB or eNodeB) in a long term evolution (LTE) system, or a next generation radio access network (NG RAN) device, or a gNB in an NR system, or a wireless controller in a cloud radio access network (CRAN), or the network device 120 may be a relay station, an access point, an in-vehicle device, a wearable device, a hub, a switch, a bridge, a router, or a network device in a future evolved public land mobile network (PLMN).

The terminal device 110 may be any terminal device, which includes but is not limited to a terminal device that is connected to the network device 120 or another terminal device by using a wired or wireless connection.

For example, the terminal device 110 may be an access terminal, a user equipment (UE), a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a session initiation protocol (SIP) phone, an IoT device, a satellite handheld terminal, a wireless local loop (WLL) station, a personal digital assistant (PDA), a handheld device with a wireless communication function, a computing device, another processing device connected to a wireless modem, an in-vehicle device, a wearable device, a terminal device in a 5G network, or a terminal device in a future evolved network.

The terminal device 110 may be configured for device to device (D2D) communication.

The wireless communications system 100 may further include a core network device 130 that communicates with a base station. The core network device 130 may be a 5G core network (5G Core, 5GC) device, for example, an access and mobility management function (AMF), for another example, an authentication server function (AUSF), for another example, a user plane function (UPF), or for another example, a session management function (SMF). Optionally, the core network device 130 may also be an evolved packet core (EPC) device of an LTE network, for example, a session management function+core packet gateway (SMF+PGW-C) device of a core network. It should be understood that the SMF+PGW-C may implement both a function that can be implemented by an SMF and a function that can be implemented by a PGW-C. In a network evolution process, the foregoing core network device may also be called another name, or a new network entity may be formed by dividing a function of the core network, which is not limited in this embodiment of this application.

Communication between functional units in the communications system 100 may be further implemented by establishing a connection by using a next generation (NG) interface.

For example, the terminal device establishes an air interface connection to an access network device by using an NR interface, to transmit user plane data and control plane signaling. The terminal device may establish a control plane signaling connection to an AMF by using an NG interface 1 (N1 for short). The access network device, for example, a next-generation radio access base station (gNB), may establish a user plane data connection to a UPF by using an NG interface 3 (N3 for short). The access network device may establish a control plane signaling connection to the AMF by using an NG interface 2 (N2 for short). The UPF may establish a control plane signaling connection to an SMF by using an NG interface 4 (N4 for short). The UPF may exchange user plane data with a data network by using an NG interface 6 (N6 for short). The AMF may establish a control plane signaling connection to the SMF by using an NG interface 11 (N11 for short). The SMF may establish a control plane signaling connection to a PCF by using an NG interface 7 (N7 for short).

FIG. 1 exemplarily shows a base station, a core network device, and two terminal devices. Optionally, the wireless communications system 100 may include a plurality of base station devices, and a coverage area of each base station may include another quantity of terminal devices. This is not limited in this embodiment of this application.

It should be understood that, in this embodiment of this application, each device that has a communication function in a network or a system may be referred to as a communications device. The communications system 100 shown in FIG. 1 is used as an example. The communications device may include a network device 120 and a terminal device 110 that have a communication function. The network device 120 and the terminal device 110 may be the foregoing devices, and details are not described herein again. The communications device may further include another device in the communications system 100, such as a network controller and a mobility management entity. This is not limited in this embodiment of this application.

It should be understood that the terms “system” and “network” may often be used interchangeably herein. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

It should be further understood that the term “corresponding” mentioned in embodiments of this application may mean that there is a direct or indirect correspondence between two elements, or that there is an association between two elements, or that there is a relationship of “indicating” and “being indicated”, “configuring” and “being configured”, or the like. It should be further understood that the “predefined” or “predefined rule” mentioned in embodiments of this application may be implemented in a manner in which corresponding code, a table, or other related information may be pre-stored in a device (for example, including a terminal device and a network device). A specific implementation is not limited in this application. For example, pre-defining may refer to being defined in a protocol. It should be further understood that in embodiments of this application, the “protocol” may refer to a standard protocol in the communication field, for example, may include an LTE protocol, an NR protocol, and a related protocol applied to a future communications system. This is not limited in this application. It should be further noted that the term “indication” in embodiments of this application may be a direct indication, an indirect indication, or an association relationship. For example, if A indicates B, it may mean that A directly indicates B, for example, B can be obtained from A. Alternatively, it may mean that A indicates B indirectly, for example, A indicates C, and B can be obtained from C. Alternatively, it may mean that there is an association relationship between A and B.

When a user who is using a network service moves from one cell to another cell, or due to reasons such as adjustment of a load of a wireless transmission service, activation operation and maintenance, and a device fault, to ensure continuity of communication and quality of service, the system needs to transfer a communication link between the user and an original cell to a new cell, that is, execute a handover process.

An Xn interface handover process is used as an example. The handover process may be divided into the following three phases:

(1) Handover preparation phase: including measurement control and reporting, and handover request and acknowledgment. A handover acknowledgment message includes a handover command generated by a target cell. A source cell is not allowed to make any modification of the handover command generated by the target cell, but directly forwards the handover command to a UE.

(2) Handover execution phase: The UE executes a handover process immediately after receiving the handover command, that is, the UE disconnects from the source cell and connects to the target cell (for example, executes random access, and sends an RRC handover complete message to a target base station). Further, sequence number (SN) status transfer and data forwarding are performed.

(3) Handover complete phase: The target cell executes path switch with an AMF and a UPF, and releases a UE context of a source base station.

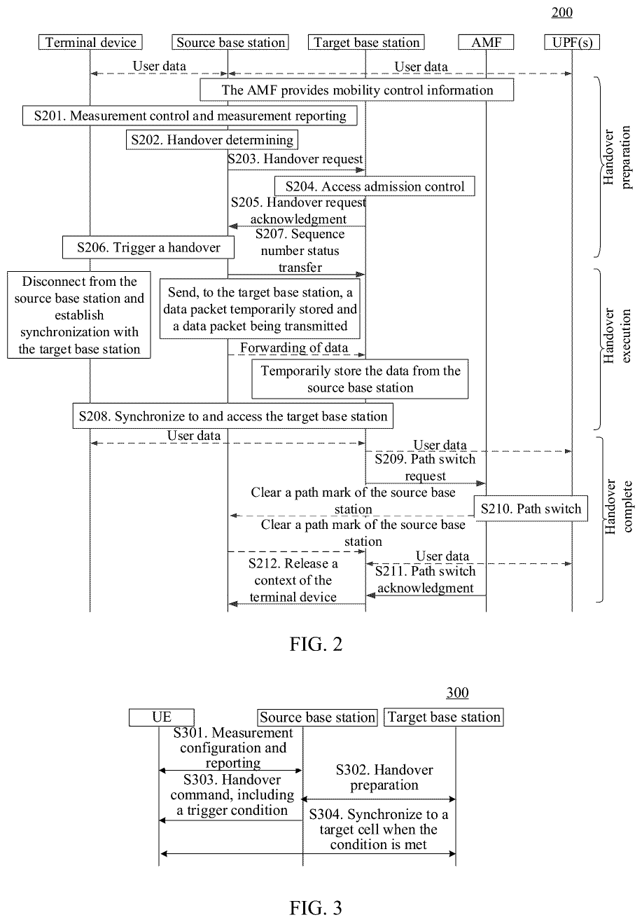

FIG. 2 is a schematic block diagram of a cell handover method according to an embodiment of this application.

As shown in FIG. 2, a handover preparation phase (S201 to S205) may include:

In S201, a source base station triggers a terminal device to measure a neighboring cell, so that the terminal device may measure the neighboring cell, and report a measurement result to the source base station.

In S202, the source base station evaluates the measurement result reported by the terminal device, to determine whether to trigger a handover.

In S203, if the source base station decides to trigger a handover, the source base station may send a handover request to a target base station.

In S204, after receiving the handover request sent by the source base station, the target base station may start access admission according to service information carried by the source base station, and perform radio resource configuration.

In S205, the target base station sends a handover request acknowledgment message to the source base station, and returns, to the source base station, an admission result and radio resource configuration information that are in the target base station. So far, the handover preparation phase is completed.

As shown in FIG. 2, a handover execution phase (S206 to S208) may include:

In S206, after receiving the handover request acknowledgment message of the target base station, the source base station may trigger the terminal device to perform a handover.

In S207, the source base station may forward, to the target base station, buffer data, a data packet that is being transmitted, a system sequence number of the data, and the like. In addition, the target base station may buffer the data received from the source base station.

In addition, the terminal device may disconnect from the source base station and establish synchronization with the target base station.

In S208, the terminal device synchronizes to the target base station. So far, the handover execution phase is completed.

As shown in FIG. 2, a handover complete phase (S209 to S212) may include:

In S209, the target base station sends a path switch request to an access and mobility management function (AMF).

In S210, after receiving the path switch request of the target base station, the AMF executes path switch with a user plane function (UPF), to clear a path mark of a user plane of the source base station.

In S211, after the path switch is completed, the AMF may send a path switch acknowledgment message to the target base station.

In S212, the target base station sends a terminal device context release message to the source base station, notifies the source base station that the handover succeeds, and triggers the source base station to release a context of the terminal device. So far, the handover is completed.

After receiving the handover command, the terminal device immediately starts a T304 timer, starts downlink synchronization to a target cell, obtains MIB information of the target cell, and then initiates random access. In a random access process, a plurality of times of preamble retransmission is allowed until the random access succeeds. Further, if the T304 timer expires, it indicates that the handover fails. The terminal device may directly trigger an RRC connection reestablishment process.

In addition, in some special scenarios, for example, when the UE moves at a high speed or at a high frequency, a handover need to be performed frequently.

To avoid a problem that a handover preparation time is too long and therefore a time that the UE is to be handed over is too late, this application provides a cell handover method based on a conditional handover, that is, a handover command (HO command) is configured for the UE in advance. In addition, in a high-speed railway scenario, because a moving trajectory of the UE is specific, the source base station may allocate the target base station to the UE in advance, and add, in the handover command, a condition used to trigger the UE to perform a cell handover. When the configured condition is met, the UE initiates an access request to the target base station.

FIG. 3 is a schematic flowchart of a conditional handover 300 according to an embodiment of this application.

As shown in FIG. 3, the conditional handover 300 may include:

S301. A UE station receives measurement configuration sent by a source base station, and reports, to the source base station, a measurement result of measurement performed based on the measurement configuration.

S302. The source base station performs handover preparation with a target base station.

S303. The source base station sends a handover command to a UE, where the handover command may include a condition used to trigger the UE to perform a cell handover, and when the configured condition is met, the UE initiates an access request to the target base station.

S304. A terminal device synchronizes to the target base station to complete the cell handover.

It should be noted that, during the conditional handover, a plurality of target cells may be configured in the handover command. In this case, the UE may determine, based on the configured condition, a target cell that the UE is to access.

In addition, generally, a cell handover procedure is implemented based on measurement reporting of a terminal and network configuration. However, measurement reporting of a terminal and network configuration are necessarily related to interaction of a plurality of pieces of signaling, so that a relatively large delay exists in a cell handover. Therefore, a wireless communication method is urgently needed in the art to reduce a handover delay. In view of this, embodiments of this application provide a wireless communication method, a terminal device, and a network device, which can reduce a handover delay.

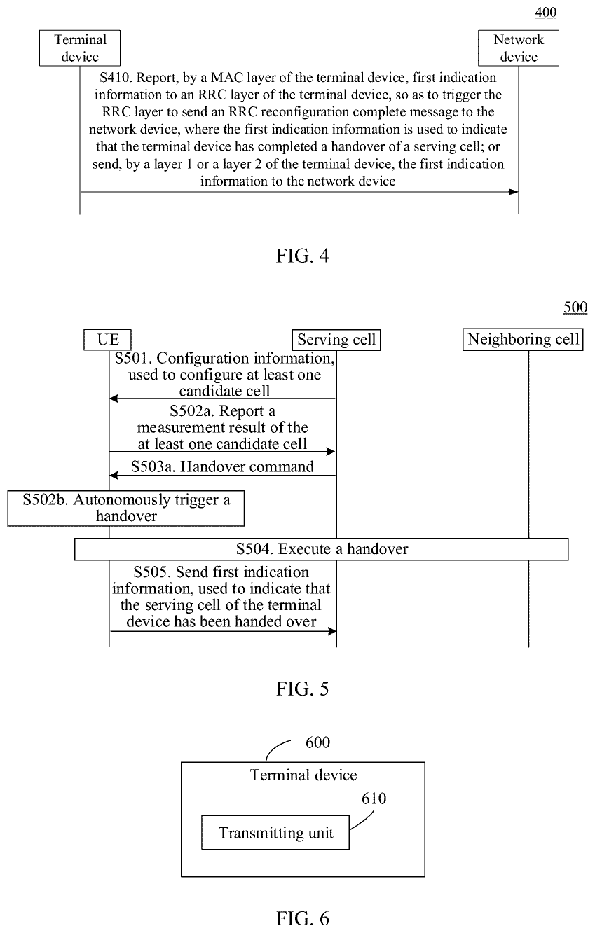

FIG. 4 is a schematic flowchart of a wireless communication method 400 according to an embodiment of this application. The wireless communication method 400 may be executed by a terminal device and a network device interactively. The terminal device shown in FIG. 4 may be the terminal devices shown in FIG. 1, and the network device shown in FIG. 4 may be the access network device shown in FIG. 1. Certainly, in terms of a cell handover, the network device shown in FIG. 4 may also be referred to as a target network device or a target base station.

As shown in FIG. 4, the method 400 may include:

S410. Report, by a medium access control (MAC) layer of the terminal device, first indication information to a radio resource control (RRC) layer of the terminal device, so as to trigger the RRC layer to send an RRC reconfiguration complete message to the network device, where the first indication information is used to indicate that the terminal device has completed a handover of a serving cell; or send, by a layer 1 or a layer 2 of the terminal device, the first indication information to the network device.

In other words, the terminal device may report the first indication information to a higher layer from a lower layer, so as to trigger the higher layer to send the RRC reconfiguration complete message to the network device, or when sending, by the lower layer, the first indication information to the network device, the terminal device may add the first indication information in lower layer signaling.

For example, the higher layer may include a layer 3.

For example, the layer 3 is configured to transfer a control message. For example, the layer 3 may include an internet protocol (IP) layer, a radio resource control (RRC) layer, and a non-access stratum (NAS).

For example, the lower layer may include a layer 2 and/or a layer 1.

For example, the layer 2 is configured to provide proper transmission and reception of signaling messages, including partial repetition detection. For example, the layer 2 may include a packet data convergence protocol (PDCP) layer, a radio link control (RLC) layer, a medium access control (MAC) layer, and the like.

For example, the layer 1 is configured to provide a transmission and reception radio link between a base station and a terminal device. For example, the layer 1 may include a physical layer.

For example, the terminal device may report, by the MAC layer of the layer 2, the first indication information to the RRC layer of the layer 3, so as to trigger the RRC layer to send the RRC reconfiguration complete message to the network device, or when sending, by the physical layer of the layer 1 or the MAC layer of the layer 2, the first indication information to the network device, the terminal device may add the first indication information in signaling sent by the layer 1 or signaling sent by the layer 2.

For example, after a cell handover based on the layer 1 or the layer 2 is completed, the first indication information is reported, by the MAC layer of the terminal device, to the RRC layer of the terminal device, so as to trigger the RRC layer to send the RRC reconfiguration complete message to the network device; or send, by the layer 1 or the layer 2 of the terminal device, the first indication information to the network device after the cell handover based on the layer 1 or the layer 2 is completed.

For example, the terminal device reports, by the MAC layer of the terminal device, the first indication information to the RRC layer of the terminal device, so as to trigger the RRC layer to send the RRC reconfiguration complete message to a network device serving a target cell; or send, by the layer 1 or the layer 2 of the terminal device, the first indication information to the network device serving the target cell after the cell handover based on the layer 1 or the layer 2 is completed.

In this embodiment, considering that a handover based on a lower layer (for example, a handover based on a layer 1 and/or a layer 2) can effectively reduce a cell handover delay, in this application, first indication information that is used to indicate that a terminal device has completed a handover of a serving cell is reported, by a MAC layer of the terminal device, to an RRC layer of a terminal device, so as to trigger the RRC layer to send an RRC reconfiguration complete message to the network device, or send, by a layer 1 or a layer 2 of the terminal device, the first indication information to the network device. Therefore, the terminal device can successfully send the first indication information to the network device after completing the handover based on a lower layer. This not only helps the terminal device implement, based on the lower layer, the handover of the serving cell of the terminal device, but also can further reduce a cell handover delay.

It should be understood that the handover based on the layer 1 and/or the layer 2 in this application may refer to a handover process triggered by signaling of a lower layer (for example, the layer 1 and/or the layer 2). For example, the network device pre-configures at least one candidate cell for the terminal device, and the terminal device performs the handover of the serving cell based on the pre-configured at least one candidate cell.

It should be further understood that, that the terminal device has completed a handover of a serving cell in this application may refer to that the terminal device has completed the handover of the serving cell from a source cell to a target cell. A network device serving the target cell and a network device serving the source cell may be the same or different. In addition, the source cell and the target cell may be distinguished by using different cell identifiers, or may be distinguished by using different transmission reception points (TRP), or may be distinguished by using different reference signal sets, or may be distinguished by using different resources, for example, different control resource sets (CORESET) or different control resource set pools (CORESET pool), or may be distinguished by using different hybrid automatic repeat requests (HARQ) processes, or may be distinguished by using different protocol stacks, for example, a service data adaptation protocol (SDAP) layer protocol stack, a packet data convergence protocol (PDCP) layer protocol stack, a radio link control (RLC) layer protocol stack, a medium access control (MAC) layer protocol stack, or a physical layer protocol stack. This is not specifically limited in this application.

In some embodiments, when the first indication information is sent by the layer 1 or the layer 2, the first indication information includes at least one of the following information:
second indication information, where the second indication information is used to indicate an identifier of a target cell;
third indication information, where the third indication information is used to indicate parameter information that is recommended by the terminal device for downlink transmission; and
a radio resource control (RRC) transaction identifier (RRC-Transaction Identifier).

For example, the second indication information includes at least one bit. When a value of a first bit in the at least one bit is a first value, it indicates that a candidate cell corresponding to the first bit is the target cell; when the value of the first bit is a second value, it indicates that the candidate cell corresponding to the first bit is not the target cell. In an implementation, the first value is 0 and the second value is 1. In another implementation, the first value is 1 and the second value is 0.

For example, a quantity of the at least one bit is the same as a quantity of candidate cells pre-configured by the network device for the terminal device.

For example, the second indication information may include the identifier of the target cell.

For example, the third indication information may include information used to determine the parameter information.

For example, the third indication information may include the parameter information.

For example, the RRC transaction identifier may be used to indicate downlink transmission to which the first indication information responds.

In some embodiments, the parameter information includes at least one of the following information: a beam, a transmission configuration indication (TCI) state, a synchronization signal and/or physical broadcast channel block (SSB), a channel state information reference signal (CSI-RS), and a sounding reference signal (SRS).

In other words, the parameter information may include information that is recommended by the terminal device for downlink transmission, such as a beam, a TCI state, an SSB, a CSI-RS, an SRS, and the like. Certainly, in another alternative embodiment, the parameter information may further include other parameter information used for downlink transmission. For example, the parameter information may further include another reference signal used for downlink transmission, or may even include resource information used for downlink transmission.

In some embodiments, when the first indication information is sent by the layer 1 or the layer 2, the first indication information is carried in uplink control information (UCI) or medium access control (MAC) control element (CE) signaling.

For example, the first indication information may be sent by the MAC layer in the layer 2 or the physical layer in the layer 1.

Certainly, in another alternative embodiment, the first indication information may also be sent by another layer in the layer 2, which is not specifically limited in this application.

In some embodiments, the RRC reconfiguration complete message is transmitted over a signaling radio bearer (SRB) 1 or an SRB 3.

In some embodiments, that the terminal device has completed a handover of a serving cell includes:
the terminal device has successfully completed a random access process.

For example, in a case in which the terminal device has completed the random access process, it may be determined that the terminal device has completed the handover of the serving cell. Alternatively, that the terminal device has completed the random access process may be used as a condition for determining that the terminal device has completed the handover of the serving cell.

For example, after a random access process for L1/L2 handover is successfully completed, an MAC entity shall indicate the successful completion of the random access process to upper layers. (Upon successful completion of the Random Access procedure initiated for L1/L2 handover, the MAC entity shall indicate the successful completion of the Random Access procedure to the upper layers.)

For example, when the terminal device is in an asynchronous state, that the terminal device has completed a handover of a serving cell includes: the terminal device has successfully completed a random access process.

For example, that the terminal device is in an asynchronous state means that the terminal device is in a state in which uplink synchronization has not been obtained but needs to be obtained.

For example, that the terminal device is in an asynchronous state means that the terminal device is in a state in which a random access process needs to be executed.

For example, that the terminal device is in an asynchronous state means that the terminal device is in a state in which uplink synchronization needs to be obtained by using a random access process.

In some embodiments, that the random access process has been completed successfully includes:
the terminal device has successfully completed conflict resolution of random access.

For example, in a case in which the terminal device has successfully completed the conflict resolution of random access, it may be determined that the terminal device has completed the handover of the serving cell. Alternatively, that the terminal device has successfully completed the conflict resolution of random access may be used as a condition for determining that the terminal device has completed the handover of the serving cell.

In some embodiments, that the terminal device has completed a handover of a serving cell includes at least one of the following:
the terminal device receives a physical downlink control channel (PDCCH) sent by a target cell;
the terminal device receives a downlink message for resolving a contention conflict; and
the terminal device receives an uplink resource scheduled by a PDCCH.

In other words, when the terminal device receives the PDCCH sent by the target cell, and/or the terminal device receives the downlink message for resolving a contention conflict, and/or the terminal device receives the uplink resource scheduled by the PDCCH, it may be determined that the terminal device has completed the handover of the serving cell.

For example, when the terminal device is in a synchronous state, that the terminal device has completed a handover of a serving cell includes at least one of the following:
the terminal device receives a PDCCH sent by a target cell;
the terminal device receives a downlink message for resolving a contention conflict; and
the terminal device receives an uplink resource scheduled by a PDCCH.

For example, that the terminal device is in a synchronous state means that the terminal device is in a state in which uplink synchronization has been obtained.

For example, that the terminal device is in a synchronous state means that the terminal device is in a state in which uplink transmission can be performed without executing a random access process.

For example, that the terminal device is in a synchronous state refers to that a cell handover process executed by the terminal is a handover process without a random access channel (RACH-LESS). The handover process without a random access channel refers to that during the handover, when the terminal device starts transmission in the target cell for the first time, a random access process is not executed in the target cell that undergoes the handover.

In some embodiments, the downlink message includes a terminal contention resolution identity MAC CE (UE Contention Resolution Identity MAC CE).

For example, the terminal contention resolution identity MAC CE may be carried in a message 4 (Msg 4), that is, in a case in which the message 4 is decoded correctly, if the terminal contention resolution identity MAC CE is obtained by means of parsing, and content of the terminal contention resolution identity MAC CE is consistent with an identity of a terminal device carried in a transmitted message 3 (Msg 3), it is considered that random access succeeds.

In some embodiments, the method 400 may further include:
triggering the terminal device to determine whether the terminal device has completed the handover of the serving cell when the terminal device meets at least one of the following:
the terminal device receives a handover command;
the terminal device has applied configuration sent by a target cell; and
the terminal device has been triggered to be handed over to the target cell.

For example, that the terminal device receives a handover command may refer to that the terminal device receives a handover command sent by the network device serving the source cell.

For example, at least one of the following may be used as a trigger condition for the terminal device to determine whether the terminal device has completed the handover of the serving cell: the terminal device receives a handover command; the terminal device has applied configuration sent by a target cell; and the terminal device has been triggered to be handed over to the target cell.

In some embodiments, the configuration sent by the target cell includes at least one of the following configuration:
configuration of radio link control (RLC), configuration of medium access control (MAC), and configuration of a physical (PHY) layer.

Certainly, the configuration sent by the target cell that has been applied by the terminal device may also be another configuration related to a cell handover based on the layer 1 or the layer 2, which is not specifically limited in this application.

In some embodiments, that the terminal device has been triggered to be handed over to the target cell includes: the terminal device has been triggered, based on a configured handover condition, to be handed over to the target cell, and/or, the terminal device has been triggered, based on the handover command, to be handed over to the target cell. In other words, regardless of whether the handover condition configured by the network device triggers the terminal device to be handed over to the target cell or the handover command sent by the network device triggers the terminal device to be handed over to the target cell, it may be understood that the terminal device has been triggered to be handed over to the target cell.

For example, the handover condition may be configured by the network device serving the source cell.

For example, that the terminal device has been triggered, based on a configured handover condition, to be handed over to the target cell may be understood as that the terminal device has been triggered to be handed over to the target cell autonomously.

In some embodiments, the method 400 may further include:
receiving configuration information, where the configuration information is used to configure at least one candidate cell; and
handing over the serving cell of the terminal device to a target cell based on the at least one candidate cell, where the at least one candidate cell includes the target cell.

For example, the configuration information may be carried in RRC signaling or other signaling.

For example, the terminal device receives the configuration information sent by the network device serving the source cell, and hands over the serving cell of the terminal device to the target cell based on the at least one candidate cell.

In some embodiments, the configuration information includes measurement reporting configuration. The terminal device reports a measurement result of the at least one candidate cell based on the measurement reporting configuration; receives a handover command; and, in response to the handover command, hands over the serving cell of the terminal device to the target cell.

For example, the handover command may be sent by the network device serving the source cell.

For example, when the terminal device can obtain the measurement reporting configuration configured by the network device serving the source cell, the terminal device may report the measurement result of the at least one candidate cell to the network device serving the source cell based on the measurement reporting configuration. After receiving the measurement result of the at least one candidate cell, the network device serving the source cell may determine whether to execute a handover, and in a case in which it is determined to execute a handover, send a handover command to the terminal device, so as to instruct the terminal device to hand over the serving cell of the terminal device to the target cell.

In some embodiments, the configuration information includes configuration of a handover condition. When a first candidate cell that meets the handover condition exists in the at least one candidate cell, the terminal device determines the first candidate cell as the target cell, and hands over the serving cell of the terminal device to the target cell.

For example, when the terminal device can obtain the configuration of the handover condition configured by the network device serving the source cell, the terminal device may autonomously hand over the serving cell of the terminal device based on the handover condition. For example, when the first candidate cell in the at least one candidate cell meets the handover condition, the terminal device may be triggered to hand over the serving cell of the terminal device to the first candidate cell, that is, the terminal device uses the first candidate cell as the target cell for a cell handover.

In some embodiments, the handover command is carried in a MAC CE or downlink control information (DCI).

In other words, the handover command may be sent by the MAC layer in the layer 2 or the physical layer in the layer 1. Certainly, in another alternative embodiment, the handover command may also be sent by the RRC layer. This is not specifically limited in this application.

FIG. 5 is a schematic flowchart of a wireless communication method 500 according to an embodiment of this application.

As shown in FIG. 5, the method 500 may include:

S501. A serving cell sends configuration information to a terminal device, where the configuration information is used to configure at least one candidate cell.

Optionally, the configuration information includes at least one of the following: configuration information of the at least one candidate cell, configuration of a handover condition used by the terminal to trigger a handover, and measurement reporting configuration.

S502a. The terminal device executes measurement based on the measurement reporting configuration and reports a measurement result of the at least one candidate cell to the serving cell.

S503a. The serving cell sends a handover command to the terminal device based on the measurement result reported by the terminal device.

Optionally, the handover command may be carried in L1 and/or L2 signaling. For example, the handover command may be carried in a MAC CE or DCI.

S502b. If the terminal device autonomously triggers a handover, the terminal device monitors the configured at least one candidate cell based on a configured handover condition, and when a candidate cell meets the handover condition, the terminal uses the candidate cell that meets the handover condition as a target cell for a cell handover.

S504. Regardless of whether a handover condition configured by the serving cell triggers the terminal device to be handed over to the target cell, or a handover command sent by the serving cell triggers the terminal device to be handed over to the target cell, after the terminal device is triggered to execute a cell handover, the terminal device hands over the serving cell of the terminal device to the target cell.

S505. After completing the handover of the serving cell, the terminal device sends first indication information to the serving cell, where the first indication information is used to indicate that the serving cell of the terminal device has been handed over.

It should be understood that for a solution in which the terminal device sends the first indication information to the serving cell, refer to the descriptions in the method 400. To avoid repetition, details are not described herein again.

It should also be understood that FIG. 5 is merely an example of this application, and shall not be construed as a limitation on this application.

For example, before the terminal device performs a cell handover, the serving cell of the terminal device is a source cell, and after the cell handover is executed, the serving cell of the terminal device is a target cell. In this application, a network device serving a source cell and a network device serving a target cell are a same network device, or may be different network devices. This is not specifically limited in this application.

The foregoing describes in detail the preferred implementations of this application with reference to the accompanying drawings. However, this application is not limited to specific details in the foregoing implementation. Within a technical concept scope of this application, a plurality of simple variations of the technical solutions of this application may be performed, and these simple variations are all within the protection scope of this application. For example, each specific technical feature described in the foregoing specific implementations may be combined in any suitable manner without contradiction. To avoid unnecessary repetition, various possible combination manners are not described otherwise in this application. For another example, any combination may also be performed between different implementations of this application, provided that the combination is not contrary to the idea of this application, the combination shall also be considered as the content disclosed in this application.

It should be further understood that, in the method embodiments of this application, sequence numbers of the foregoing processes do not mean execution sequences. The execution sequences of the processes shall be determined according to functions and internal logic of the processes, and shall not be construed as any limitation on the implementation processes of embodiments of this application. In addition, in embodiments of this application, the terms “downlink” and “uplink” are used to indicate a transmission direction of a signal or data, where “downlink” indicates that a transmission direction of a signal or data is a first direction from a station to a user equipment in a cell, and “uplink” indicates that a transmission direction of a signal or data is a second direction from a user equipment in a cell to a station. For example, a “downlink signal” indicates that a transmission direction of the signal is the first direction. In addition, in embodiments of this application, the term “and/or” is merely used to describe an association relationship between associated objects, and represents that there may be three relationships. Specifically, A and/or B may represent three cases: only A exists, both A and B exist, and only B exists. In addition, the character “/” in this specification generally indicates an “or” relationship between the associated objects.

The foregoing describes the method embodiments of this application in detail with reference to FIG. 1 to FIG. 5. The following describes the apparatus embodiments of this application in detail with reference to FIG. 6 to FIG. 9.

FIG. 6 is a schematic block diagram of a terminal device 600 according to an embodiment of this application.

As shown in FIG. 6, the terminal device 600 may include:
a transmitting unit 610, configured to: report, by a medium access control MAC layer of the terminal device, first indication information to a radio resource control RRC layer of the terminal device, so as to trigger the RRC layer to send an RRC reconfiguration complete message to a network device, where the first indication information is used to indicate that the terminal device has completed a handover of a serving cell; or
send, by a layer 1 or a layer 2 of the terminal device, the first indication information to the network device.

In some embodiments, when the first indication information is sent by the layer 1 or the layer 2, the first indication information includes at least one of the following information:
second indication information, where the second indication information is used to indicate an identifier of a target cell;
third indication information, where the third indication information is used to indicate parameter information that is recommended by the terminal device for downlink transmission; and
a radio resource control RRC transaction identifier RRC-Transaction Identifier.

In some embodiments, the parameter information includes at least one of the following information: a beam, a transmission configuration indication TCI state, a synchronization signal and/or physical broadcast channel block SSB, a channel state information reference signal CSI-RS, and a sounding reference signal SRS.

In some embodiments, when the first indication information is sent by the layer 1 or the layer 2, the first indication information is carried in uplink control information UCI or medium access control control element MAC CE signaling.

In some embodiments, the RRC reconfiguration complete message is transmitted over a signaling radio bearer SRB 1 or an SRB 3.

In some embodiments, that the terminal device has completed a handover of a serving cell includes:
the terminal device has successfully completed a random access process.

In some embodiments, that the random access process has been completed successfully includes:
the terminal device has successfully completed conflict resolution of random access.

In some embodiments, that the terminal device has completed a handover of a serving cell includes at least one of the following:
the terminal device receives a physical downlink control channel PDCCH sent by a target cell;
the terminal device receives a downlink message for resolving a contention conflict; and
the terminal device receives an uplink resource scheduled by a PDCCH.

In some embodiments, the downlink message includes a terminal contention resolution identity medium access control control element MAC CE.

In some embodiments, the transmitting unit 610 is further configured to:
trigger the terminal device to determine whether the terminal device has completed the handover of the serving cell when the terminal device meets at least one of the following:
the terminal device receives a handover command;
the terminal device has applied configuration sent by a target cell; and
the terminal device has been triggered to be handed over to the target cell.

In some embodiments, the configuration sent by the target cell includes at least one of the following configuration:
configuration of radio link control RLC, configuration of medium access control MAC, and configuration of a physical PHY layer.

In some embodiments, that the terminal device has been triggered to be handed over to the target cell includes: the terminal device has been triggered, based on a configured handover condition, to be handed over to the target cell, and/or, the terminal device has been triggered, based on the handover command, to be handed over to the target cell.

In some embodiments, the transmitting unit 610 is further configured to:
receive configuration information, where the configuration information is used to configure at least one candidate cell; and
hand over the serving cell of the terminal device to a target cell based on the at least one candidate cell, where the at least one candidate cell includes the target cell.

In some embodiments, the configuration information includes measurement reporting configuration. The transmitting unit 610 is specifically configured to:
report a measurement result of the at least one candidate cell based on the measurement reporting configuration;
receive a handover command; and
in response to the handover command, hand over the serving cell of the terminal device to the target cell.

In some embodiments, the configuration information includes configuration of a handover condition. The transmitting unit 610 is specifically configured to:
when a first candidate cell that meets the handover condition exists in the at least one candidate cell, determine the first candidate cell as the target cell; and
hand over the serving cell of the terminal device to the target cell.

In some embodiments, the handover command is carried in a medium access control control element MAC CE or downlink control information DCI.

It should be understood that the apparatus embodiments may correspond to the method embodiments, and for similar descriptions, refer to the method embodiments. Specifically, the terminal device 600 shown in FIG. 6 may correspond to a corresponding body in the method 200 for executing embodiments of this application, and the foregoing and other operations and/or functions of the units in the terminal device 600 are respectively used to implement corresponding procedures in the methods provided in embodiments of this application. For brevity, details are not described herein again.

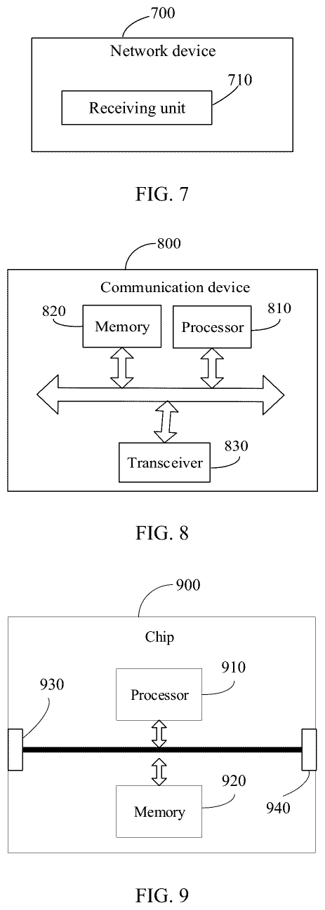

FIG. 7 is a schematic block diagram of a network device 700 according to an embodiment of this application.

As shown in FIG. 7, the network device 700 may include:
a receiving unit 710, configured to receive, by a layer 1 or a layer 2 of the network device, first indication information sent by a terminal device, where the first indication information is used to indicate that the terminal device has completed a handover of a serving cell.

In some embodiments, the first indication information includes at least one of the following:
second indication information, where the second indication information is used to indicate an identifier of a target cell;
third indication information, where the third indication information is used to indicate parameter information that is recommended by the terminal device for downlink transmission; and
a radio resource control RRC transaction identifier RRC-Transaction Identifier.

In some embodiments, the parameter information includes at least one of the following information: a beam, a transmission configuration indication TCI state, a synchronization signal and/or physical broadcast channel block SSB, a channel state information reference signal CSI-RS, and a sounding reference signal SRS.

In some embodiments, the first indication information is carried in uplink control information UCI or medium access control control element MAC CE signaling.

In some embodiments, the receiving unit 710 may be further configured to:
send configuration information to the terminal device, where the configuration information is used to configure at least one candidate cell.

In some embodiments, the receiving unit 710 may be further configured to:
send a handover command to the terminal device, where the handover command is carried in a medium access control control element MAC CE or downlink control information DCI.

In some embodiments, the configuration information includes configuration of a handover condition. The handover condition is a condition used to trigger the terminal device to hand over the serving cell of the terminal device.

It should be understood that the apparatus embodiments may correspond to the method embodiments, and for similar descriptions, refer to the method embodiments. Specifically, the network device 700 shown in FIG. 7 may correspond to a corresponding body that executes the method 300 in embodiments of this application, and the foregoing and other operations and/or functions of the units in the network device 700 are respectively used to implement corresponding procedures in the methods provided in embodiments of this application. For brevity, details are not described herein again.

The foregoing describes the communications device in embodiments of this application from a perspective of a functional module with reference to the accompanying drawings. It should be understood that the functional module may be implemented in a hardware form, may be implemented in an instruction in a software form, or may be implemented in a combination of hardware and a software module. Specifically, the steps of the method embodiments in embodiments of this application may be completed by using an integrated logic circuit of hardware in a processor and/or an instruction in a form of software. The steps of the methods disclosed with reference to embodiments of this application may be directly executed by a hardware decoding processor, or may be executed by using a combination of hardware and a software module in a decoding processor. Optionally, the software module may be located in a known storage medium in the art such as a random access memory, a flash memory, a read-only memory, a programmable read-only memory, an electrically erasable programmable memory, or a register. The storage medium is located in a memory. The processor reads information from the memory, and performs the steps in the foregoing method embodiments in combination with hardware in the processor.

For example, both the transmitting unit 610 and the receiving unit 710 in the foregoing may be implemented by a transceiver.

FIG. 8 is a schematic structural diagram of a communications device 800 according to an embodiment of this application.

As shown in FIG. 8, the communications device 800 may include a processor 810.

The processor 810 may invoke a computer program from a memory and run the computer program, so as to implement the methods in embodiments of this application.

As shown in FIG. 8, the communications device 800 may further include a memory 820.

The memory 820 may be configured to store indication information, and may be further configured to store code, an instruction, and the like that are executed by the processor 810. The processor 810 may invoke a computer program from the memory 820 and run the computer program to implement the methods in embodiments of this application. The memory 820 may be a separate component independent of the processor 810, or may be integrated into the processor 810.

As shown in FIG. 8, the communications device 800 may further include a transceiver 730.

The processor 810 may control the transceiver 830 to communicate with another device. Specifically, the processor 810 may send information or data to the another device, or receive information or data sent by the another device. The transceiver 830 may include a transmitting set and a receiving set. The transceiver 830 may further include an antenna, and a quantity of the antenna may be one or more.

It should be understood that components in the communications device 800 are connected by using a bus system. In addition to a data bus, the bus system includes a power bus, a control bus, and a status signal bus.

It should be further understood that the communications device 800 may be a terminal device in embodiments of this application, and the communications device 800 may implement a corresponding procedure implemented by the terminal device in the methods in embodiments of this application. That is, the communications device 800 in embodiments of this application may correspond to the terminal device 600 in embodiments of this application, and may correspond to a corresponding body that executes the method 200 according to embodiments of this application. For brevity, details are not described herein again. Similarly, the communications device 800 may be a network device in embodiments of this application, and the communications device 800 may implement a corresponding procedure implemented by the network device in the methods in embodiments of this application. That is, the communications device 800 in this embodiment of this application may correspond to the network device 700 in embodiments of this application, and may correspond to a corresponding body that executes the method 300 according to embodiments of this application. For brevity, details are not described herein again.

In addition, an embodiment of this application further provides a chip.

For example, the chip may be an integrated circuit chip, which has a signal processing capability, and may implement or execute the methods, steps, and logical block diagrams disclosed in embodiments of this application. The chip may also be referred to as a system-level chip, a system chip, a chip system, or a system-on-chip, or the like. Optionally, the chip may be applied to various communications devices, so that a communications device on which the chip is installed can execute the methods, steps, and logical block diagrams disclosed in embodiments of this application.

FIG. 9 is a schematic structural diagram of a chip 900 according to an embodiment of this application.

As shown in FIG. 9, the chip 900 includes a processor 810.

The processor 810 may invoke a computer program from a memory and run the computer program, so as to implement the methods in embodiments of this application.

As shown in FIG. 9, the chip 900 may further include a memory 820.

The processor 810 may invoke a computer program from the memory 820 and run the computer program to implement a method in embodiments of this application. The memory 820 may be configured to store indication information, and may be further configured to store code, an instruction, and the like that are executed by the processor 810. The memory 820 may be a separate component independent of the processor 810, or may be integrated into the processor 810.

As shown in FIG. 9, the chip 900 may further include an input interface 830.

The processor 810 may control the input interface 830 to communicate with another device or chip, and specifically, may obtain information or data sent by the another device or chip.

As shown in FIG. 9, the chip 900 may further include an output interface 840.

The processor 810 may control the output interface 840 to communicate with another device or chip, and specifically, may output information or data to the another device or chip.

It should be understood that the chip 900 may be applied to a network device in embodiments of this application, and the chip may implement a corresponding procedure implemented by the network device in the methods in embodiments of this application, or may implement a corresponding procedure implemented by a terminal device in the methods in embodiments of this application. For brevity, details are not described herein again.

It should be further understood that components in the chip 900 are connected by using a bus system. In addition to a data bus, the bus system further includes a power bus, a control bus, and a status signal bus.

The foregoing processor may include but is not limited to:
a general-purpose processor, a digital signal processor (DSP), an application-specific integrated circuit (ASIC), a field programmable gate array (FPGA) or another programmable logic device, a discrete gate or a transistor logic device, or a discrete hardware component.

The processor may be configured to implement or execute the methods, steps, and logical block diagrams disclosed in embodiments of this application. The steps of methods disclosed with reference to embodiments of this application may be directly executed by a hardware decoding processor, or may be executed by a combination of hardware and software modules in a decoding processor. The software module may be located in a mature storage medium in the art, for example, a random access memory, a flash memory, a read-only memory, a programmable read-only memory, an erasable programmable memory, or a register. The storage medium is located in a memory. The processor reads information from the memory, and completes the steps of the foregoing methods in combination with hardware in the processor.

The foregoing memory includes but is not limited to:
a volatile memory and/or a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), and is used as an external cache. By way of example but not limitative description, many forms of RAMs may be used, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM).

It should be noted that the memories described herein are intended to include these and any other suitable types of memories.

An embodiment of this application further provides a computer-readable storage medium, configured to store a computer program. The computer-readable storage medium stores one or more programs, and the one or more programs include an instruction. When the instruction is executed by a portable electronic device including a plurality of application programs, the portable electronic device can execute the wireless communication method provided in this application. Optionally, the computer-readable storage medium may be applied to a network device in embodiments of this application, and the computer program causes a computer to execute a corresponding procedure implemented by the network device in the methods in embodiments of this application. For brevity, details are not described herein again. Optionally, the computer-readable storage medium may be applied to a mobile terminal or a terminal device in embodiments of this application, and the computer program causes a computer to execute a corresponding procedure implemented by the mobile terminal or the terminal device in the methods in embodiments of this application. For brevity, details are not described herein again.

An embodiment of this application further provides a computer program product, including a computer program. Optionally, the computer program product may be applied to a network device in embodiments of this application, and the computer program causes a computer to execute a corresponding procedure implemented by the network device in the methods in embodiments of this application. For brevity, details are not described herein again. Optionally, the computer program product may be applied to a mobile terminal or a terminal device in embodiments of this application, and the computer program causes a computer to execute a corresponding procedure implemented by the mobile terminal or the terminal device in the methods in embodiments of this application. For brevity, details are not described herein again.

An embodiment of this application further provides a computer program. When the computer program is executed by a computer, the computer can execute the wireless communication methods provided in this application. Optionally, the computer program may be applied to a network device in embodiments of this application. When the computer program runs on a computer, the computer executes a corresponding procedure implemented by the network device in the methods in embodiments of this application. For brevity, details are not described herein again. Optionally, the computer program may be applied to a mobile terminal or a terminal device in embodiments of this application. When the computer program runs on a computer, the computer executes a corresponding procedure implemented by the mobile terminal or the terminal device in the methods in embodiments of this application. For brevity, details are not described herein again.

An embodiment of this application further provides a communications system. The communications system may include the terminal device and the network device in the foregoing, so as to form the communications system 100 shown in FIG. 1. For brevity, details are not described herein again. It should be noted that the term “system” and the like in this specification may also be referred to as a “network management architecture”, a “network system”, or the like.

It should be further understood that terms used in embodiments of this application and the appended claims are merely intended to describe specific embodiments, but are not intended to limit embodiments of this application. For example, the singular forms of “a/an”, “said”, “described above”, and “the” used in embodiments of this application and the appended claims are also intended to include plural forms, unless the context clearly implies otherwise.

A person of ordinary skill in the art may be aware that, units and algorithm steps in examples described in combination with embodiments disclosed in this specification can be implemented by electronic hardware or a combination of computer software and electronic hardware. Whether the functions are executed by hardware or software depends on particular applications and design constraints of the technical solutions. A person skilled in the art may use different methods for each specific application to implement the described functions, but this implementation shall not be considered as beyond the scope of embodiments of this application. When the functions are implemented in a form of a software functional unit and sold or used as an independent product, the functions may be stored in a computer-readable storage medium. Based on such an understanding, the technical solutions in embodiments of this application essentially, or the part contributing to the prior art, or some of the technical solutions may be implemented in a form of a software product. The computer software product is stored in a storage medium and includes several instructions for instructing a computer device (which may be a personal computer, a server, a network device, or the like) to execute all or some of the steps of the methods in embodiments of this application. The foregoing storage medium includes any medium that can store program code, such as a USB flash drive, a removable hard disk, a read-only memory, a random access memory, a magnetic disk, or an optical disc.

It may be aware by a person skilled in the art that, for convenience and brevity of description, for a specific working process of the foregoing described systems, apparatuses, and units, refer to corresponding processes in the foregoing method embodiments, and details are not described herein again. In the several embodiments provided in this application, it should be understood that the disclosed systems, apparatuses, and methods may be implemented in another manner. For example, the unit division, or module division, or component division in the foregoing apparatus embodiments is merely a logical function division, and there may be other divisions in actual implementation. For example, a plurality of units or modules or components may be combined or integrated into another system, or some units or modules or components may be ignored or omitted. For another example, the foregoing units, modules, or components described as separate or display components may be or may not be physically separated, that is, may be located in one place, or may be distributed on a plurality of network units. Some or all of the units, modules, or components may be selected according to an actual need to achieve the objectives of embodiments of this application. Finally, it should be noted that the foregoing displayed or discussed mutual coupling or direct coupling or communication connections may be implemented by using some interfaces. The indirect couplings or communication connections between the apparatus or units may be implemented in electronic, mechanical, or other forms.

The foregoing descriptions are merely specific implementations of embodiments of this application, but the protection scope of embodiments of this application is not limited thereto. Any variation or replacement readily figured out by a person skilled in the art within the technical scope disclosed in embodiments of this application shall fall within the protection scope of embodiments of this application. Therefore, the protection scope of embodiments of this application shall be subject to the protection scope of the claims.

What is claimed is:

1. A wireless communication method, wherein the method is applicable to a terminal device, and the method comprises:
reporting, by a medium access control (MAC) layer of the terminal device, first indication information to a radio resource control (RRC) layer of the terminal device, so as to trigger the RRC layer to send an RRC reconfiguration complete message to a network device, wherein the first indication information is used to indicate that the terminal device has completed a handover of a serving cell; or
sending, by a layer 1 or a layer 2 of the terminal device, the first indication information to the network device.

2. The method according to claim 1, wherein the RRC reconfiguration complete message is transmitted over a signaling radio bearer (SRB) 1 or an SRB 3.

3. The method according to claim 1, wherein the method further comprises:
triggering the terminal device to determine whether the terminal device has completed the handover of the serving cell when the terminal device meets at least one of following:
the terminal device receives a handover command;
the terminal device has applied configuration sent by a target cell; and
the terminal device has been triggered to be handed over to the target cell.

4. The method according to claim 3, wherein that the terminal device has been triggered to be handed over to the target cell comprises: the terminal device has been triggered, based on a configured handover condition, to be handed over to the target cell, and/or, the terminal device has been triggered, based on the handover command, to be handed over to the target cell.

5. The method according to claim 1, wherein the method further comprises:
receiving configuration information, wherein the configuration information is used to configure at least one candidate cell; and
handing over the serving cell of the terminal device to a target cell based on the at least one candidate cell, wherein the at least one candidate cell comprises the target cell.

6. The method according to claim 5, wherein the configuration information comprises measurement reporting configuration; and the handing over the serving cell of the terminal device to a target cell based on the at least one candidate cell comprises:
reporting a measurement result of the at least one candidate cell based on the measurement reporting configuration;
receiving a handover command; and
in response to the handover command, handing over the serving cell of the terminal device to the target cell.

7. The method according to claim 5, wherein the configuration information comprises configuration of a handover condition; and the handing over the serving cell of the terminal device to a target cell based on the at least one candidate cell comprises:
when a first candidate cell that meets the handover condition exists in the at least one candidate cell, determining the first candidate cell as the target cell; and
handing over the serving cell of the terminal device to the target cell.

8. The method according to claim 3, wherein the handover command is carried in a medium access control control element MAC CE or downlink control information DCI.

9. A wireless communication method, wherein the method is applicable to a network device, and the method comprises:
receiving, by a layer 1 or a layer 2 of the network device, first indication information sent by a terminal device, wherein the first indication information is used to indicate that the terminal device has completed a handover of a serving cell.

10. The method according to claim 9, wherein the method further comprises:
sending configuration information to the terminal device, wherein the configuration information is used to configure at least one candidate cell.

11. The method according to claim 10, wherein the method further comprises:
sending a handover command to the terminal device, wherein the handover command is carried in a medium access control control element (MAC CE) or downlink control information DCI.

12. The method according to claim 10, wherein the configuration information comprises configuration of a handover condition; and the handover condition is a condition used to trigger the terminal device to hand over the serving cell of the terminal device.

13. A terminal device, comprising:
a processor and a memory, wherein the memory is configured to store a computer program, and the processor is configured to invoke and run the computer program stored in the memory to cause the terminal device to perform:
reporting, by a medium access control (MAC) layer of the terminal device, first indication information to a radio resource control (RRC) layer of the terminal device, so as to trigger the RRC layer to send an RRC reconfiguration complete message to a network device, wherein the first indication information is used to indicate that the terminal device has completed a handover of a serving cell; or
sending, by a layer 1 or a layer 2 of the terminal device, the first indication information to the network device.

14. The terminal device according to claim 13, wherein the RRC reconfiguration complete message is transmitted over a signaling radio bearer (SRB) 1 or an SRB 3.

15. The terminal device according to claim 13, wherein that the terminal device has completed a handover of a serving cell comprises:
the terminal device has successfully completed a random access process.

16. The terminal device according to claim 13, wherein that the terminal device has completed a handover of a serving cell comprises at least one of following:
the terminal device receives a physical downlink control channel (PDCCH) sent by a target cell;
the terminal device receives a downlink message for resolving a contention conflict; and
the terminal device receives an uplink resource scheduled by a PDCCH.

17. The terminal device according to claim 13, wherein the processor is configured to cause the terminal device to perform:
triggering the terminal device to determine whether the terminal device has completed the handover of the serving cell when the terminal device meets at least one of following:
the terminal device receives a handover command;
the terminal device has applied configuration sent by a target cell; and
the terminal device has been triggered to be handed over to the target cell.

18. The terminal device according to claim 17, wherein that the terminal device has been triggered to be handed over to the target cell comprises: the terminal device has been triggered, based on a configured handover condition, to be handed over to the target cell, and/or, the terminal device has been triggered, based on the handover command, to be handed over to the target cell.

19. The terminal device according to claim 13, wherein the processor is configured to cause the terminal device to perform:
receiving configuration information, wherein the configuration information is used to configure at least one candidate cell; and
handing over the serving cell of the terminal device to a target cell based on the at least one candidate cell, wherein the at least one candidate cell comprises the target cell.

20. The terminal device according to claim 19, wherein the configuration information comprises measurement reporting configuration; and the handing over the serving cell of the terminal device to a target cell based on the at least one candidate cell comprises:
reporting a measurement result of the at least one candidate cell based on the measurement reporting configuration;
receiving a handover command; and
in response to the handover command, handing over the serving cell of the terminal device to the target cell.
